(19) United States
(12) Patent Application Publication
(10) Pub. No.: US 2015/0294256 A1
(43) Pub. Date: Oct. 15, 2015

(54) SCENARIO MODELING AND VISUALIZATION

(71) Applicant: Microsoft Technology Licensing, LLC, Redmond, WA (US)

(72) Inventors: Sivarudrappa Mahesh, Redmond, WA (US); Gandhi Swaminathan, Renton, WA (US); Hovhannes Sadoyan, Bellevue, WA (US); Marc Mezquita, Kirkland, WA (US); Aniket Naravanekar, Renton, WA (US); Sagar Narla, Bellevue, WA (US)

(21) Appl. No.: 14/458,960

(22) Filed: Aug. 13, 2014

Related U.S. Application Data
(60) Provisional application No. 61/978,537, filed on Apr. 11, 2014.

(51) Int. Cl. G06Q 10/06

(52) U.S. Cl. CPC G06Q 10/06393; G06Q 10/067

(57) ABSTRACT

A user provides inputs to model scenarios for which data is to be reported. These scenarios are modeled by aggregating events into activities that are then aggregated, themselves, into scenarios. A scenarios analyzer accesses data logs to extract and analyze data for the modeled scenario. The analyzed data is visualized as a histogram with roll up and drill down functionality.

### CROSS-REFERENCE TO RELATED APPLICATION

The present application is based on and claims the benefit of U.S. provisional patent application Ser. No. 61/978,537, filed Apr. 11, 2014, the content of which is hereby incorporated by reference in its entirety.

### BACKGROUND

Computer systems are currently in wide use. Some computer systems are relatively large and have a variety of different types of data collected for them, so that a user or administrator or other person can monitor the information being processed by, or performance of, the computer system.

By way of example, some such computer systems include business systems. Business systems can include, for instance, customer relations management (CRM) systems, enterprise resource planning (ERP) systems, line-of-business (LOB) systems, among others. Such business systems perform workflows and processes, and generate user interface displays that allow users to interact with the business systems. The users can do this in order to perform activities or tasks, to carry out their business.

Telemetry and analytics, in this context, refer to the processes of gathering information about such a computer system, and performing analysis on the collected information so that a user can view analysis results which indicate desired performance indicators corresponding to the computer system. Telemetry and analytics are a part of many data driven business and engineering processes in various kinds of software and services.

For example, telemetry, for many software or service usage scenarios, gathers data from many instances when the scenario is run by different users or processes. This data can be aggregated to identify scenario indicator metrics, such as key performance indicators (or KPIs). The indicator metrics are then used to compare scenario usage, performance, or reliability across different versions and demographics. Summarization and aggregation techniques are used to generate the indicator metrics, and various pivots and filters are enabled so that a user can drill down to view more detailed data, when the metrics indicate that a problem may exist with a given scenario.

Some statistical aggregations that are used in these types of analytics include timed average, median, 95th percentile, among others. These types of aggregations assume a parametric distribution of the data. However, the telemetry data may be from varied segments of the population, or be influenced by other variables, and this can contribute to the data being multi-modal or non-parametric. Thus, when the data is compared across populations, it can generate false positive or negative KPI indications, which add noise to the telemetry and analytics systems, and can render the entire report non-actionable.

Some efforts have been made to filter this type of noise. However, these efforts have proven very expensive in terms of computing overhead and labor.

Some efforts have also been made to fit data aggregation and statistical summarization to specific scenarios. However, scenario usage often changes over time due to the nature of the software business. Thus, even if the aggregations are tuned to the specific usage, pre-aggregation tuning needs to be done separately for each pivot value. Most of the pivot values (e.g., trimmed average, median, etc.) cannot be computed in a distributed manner and don't roll up or drill down with pivots. Therefore, it can be very expensive both in terms of computation and query resources to support these indicator metrics across a range of pivots, in such a way that they can be actionable indicator metrics.

The discussion above is merely provided for general background information and is not intended to be used as an aid in determining the scope of the claimed subject matter.

### SUMMARY

A user provides inputs to model scenarios for which data is to be reported. These scenarios are modeled by aggregating events into activities that are then aggregated, themselves, into scenarios. A scenario analyzer accesses data logs to extract and analyze data for the modeled scenario. The analyzed data is visualized as a histogram with roll up and drill down functionality.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIGS. 1-1 and 1-2 (collectively FIG. 1) is a block diagram of one illustrative data collection and analysis architecture.

FIG. 2 is a flow diagram illustrating one embodiment of the operation of the architecture shown in FIG. 1 in generating a scenario model.

FIGS. 2A-2F show illustrative user interface displays.

FIG. 3 is a flow diagram illustrating one embodiment of the operation of the architecture shown in FIG. 1 in analyzing data for a given scenario.

FIG. 4 is a flow diagram illustrating one embodiment of the operation of the architecture shown in FIG. 1 is generating a visualization of the analyzed scenario.

FIGS. 4A and 4B are two exemplary visualizations.

FIG. 5 shows one embodiment of the architecture of FIG. 1 deployed in a cloud computing architecture.

FIGS. 6-10 show various embodiments of mobile devices.

FIG. 11 is a block diagram of one illustrative computing environment.

### DETAILED DESCRIPTION

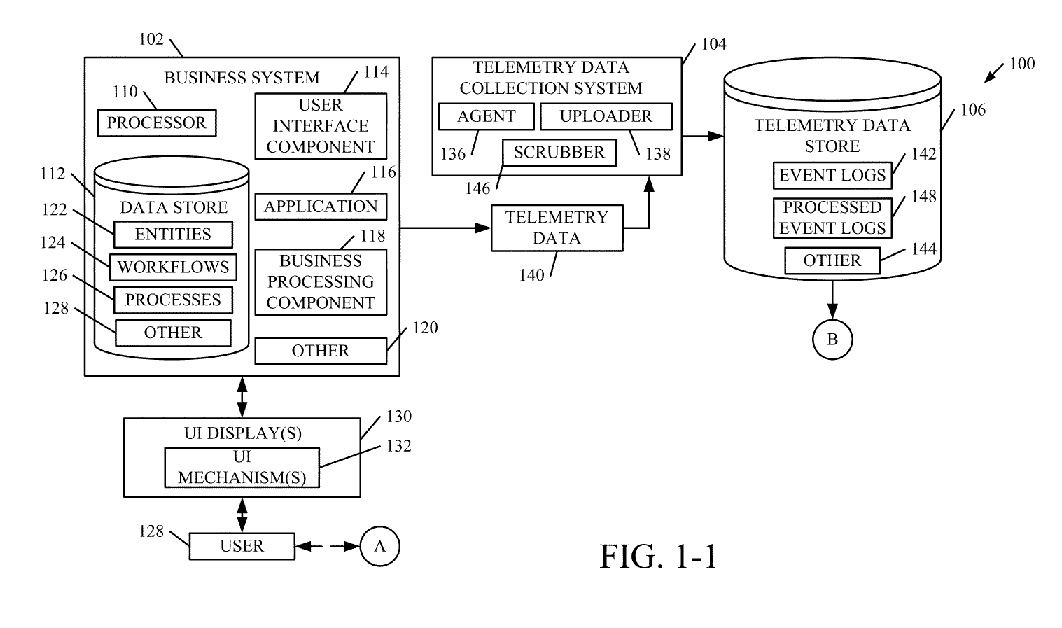

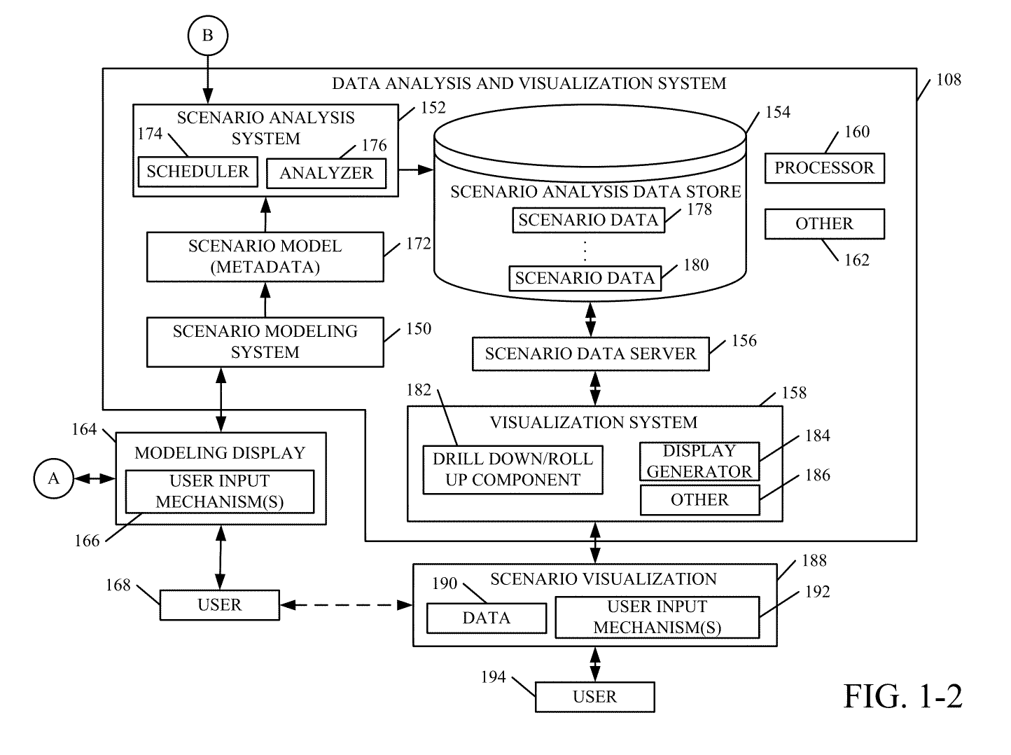

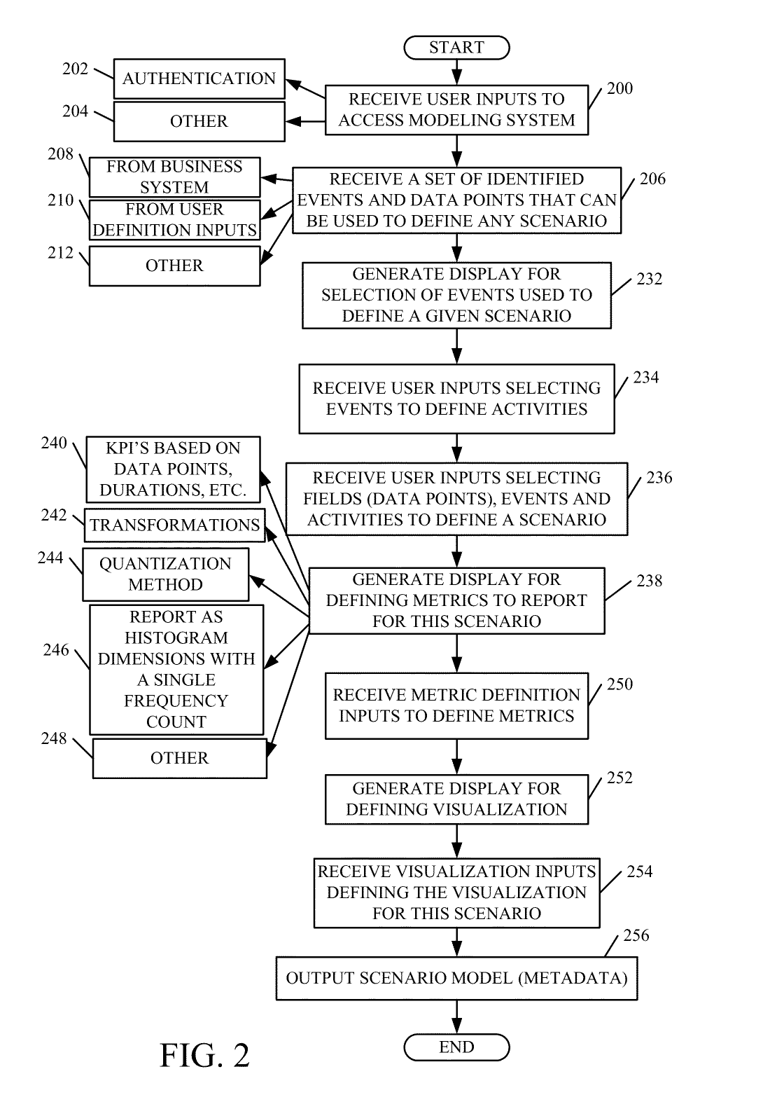

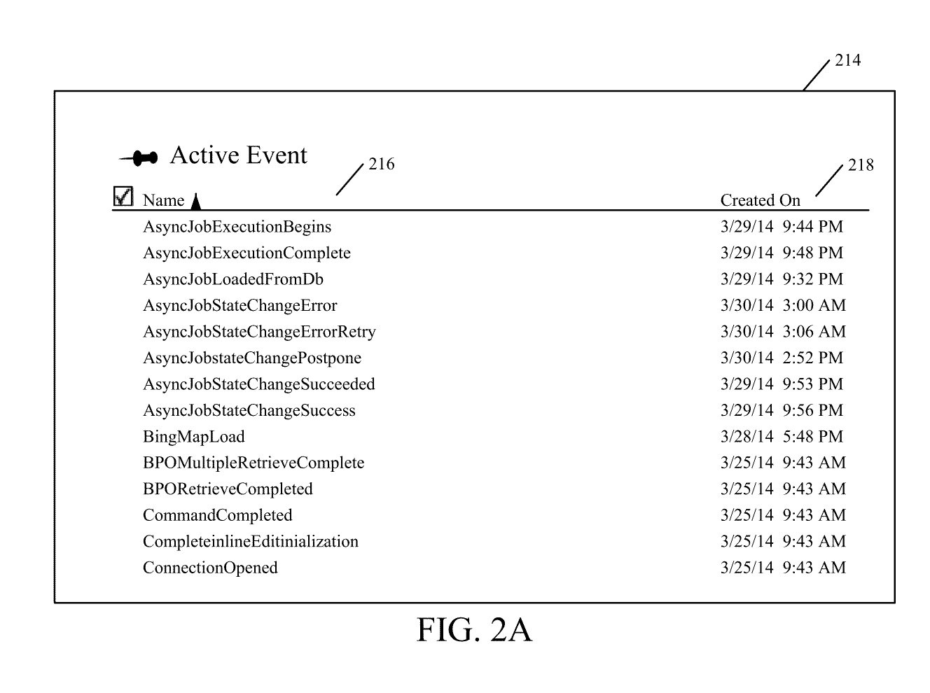

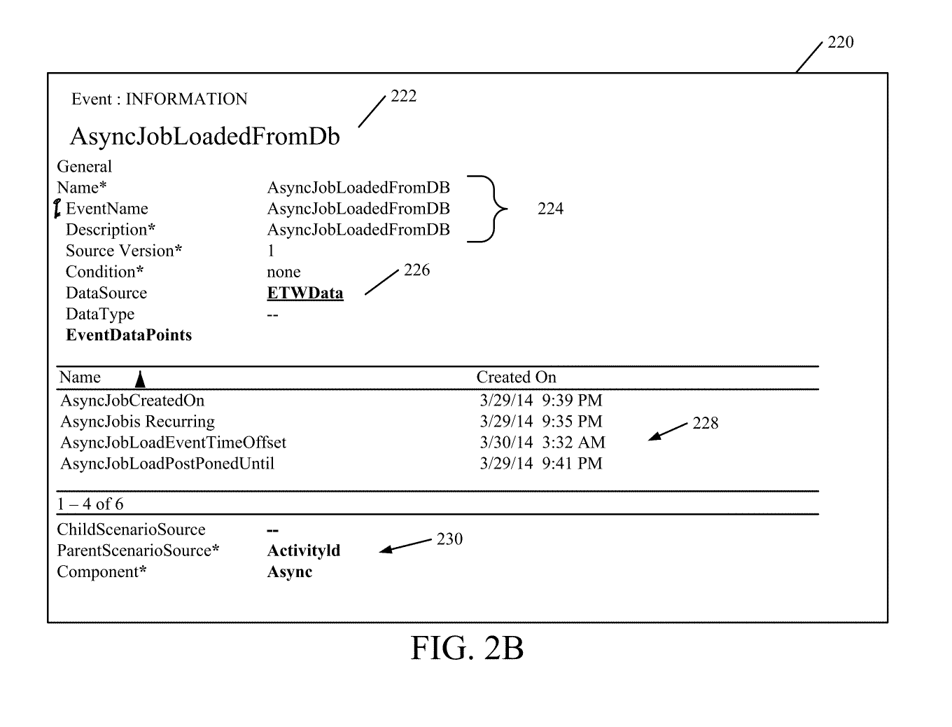

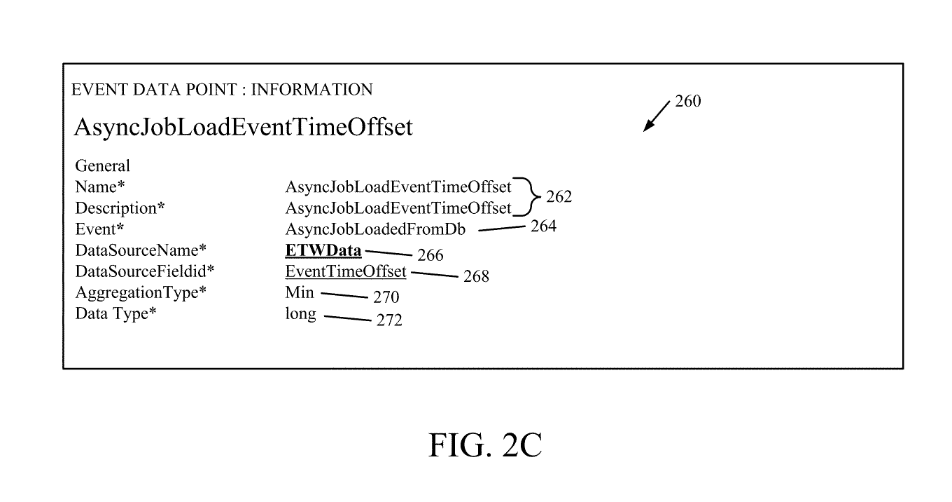

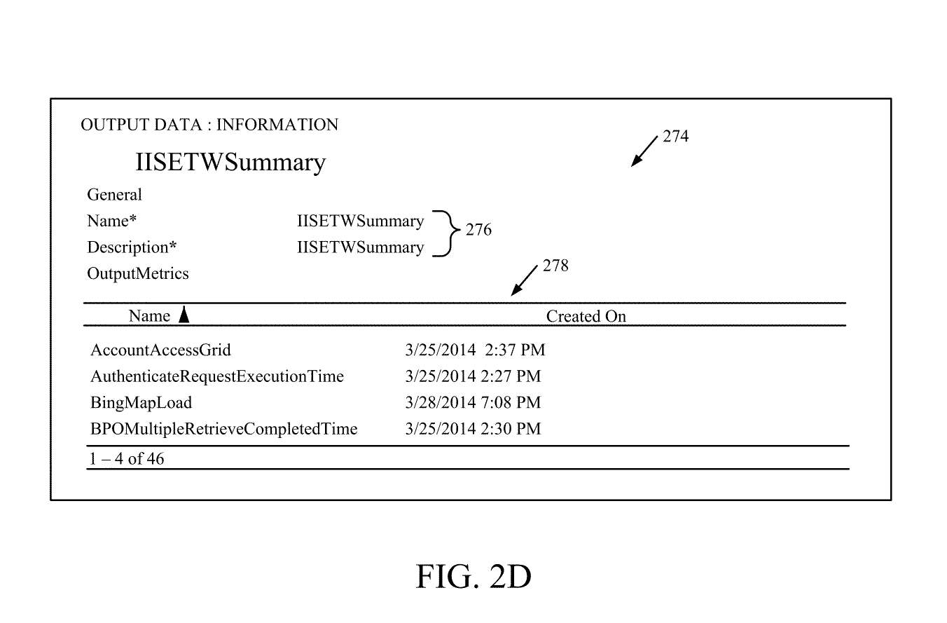

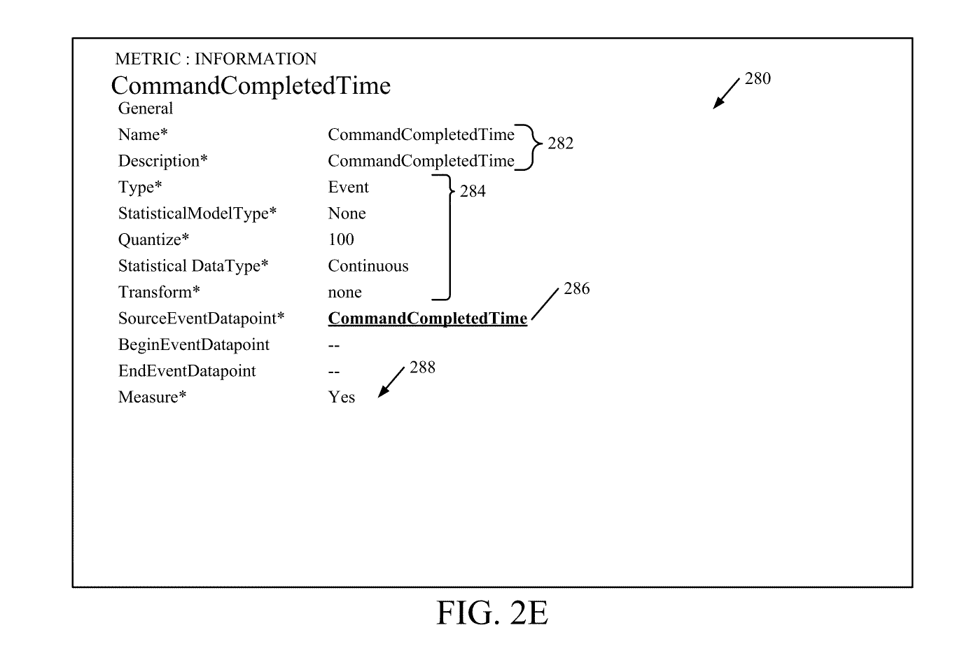

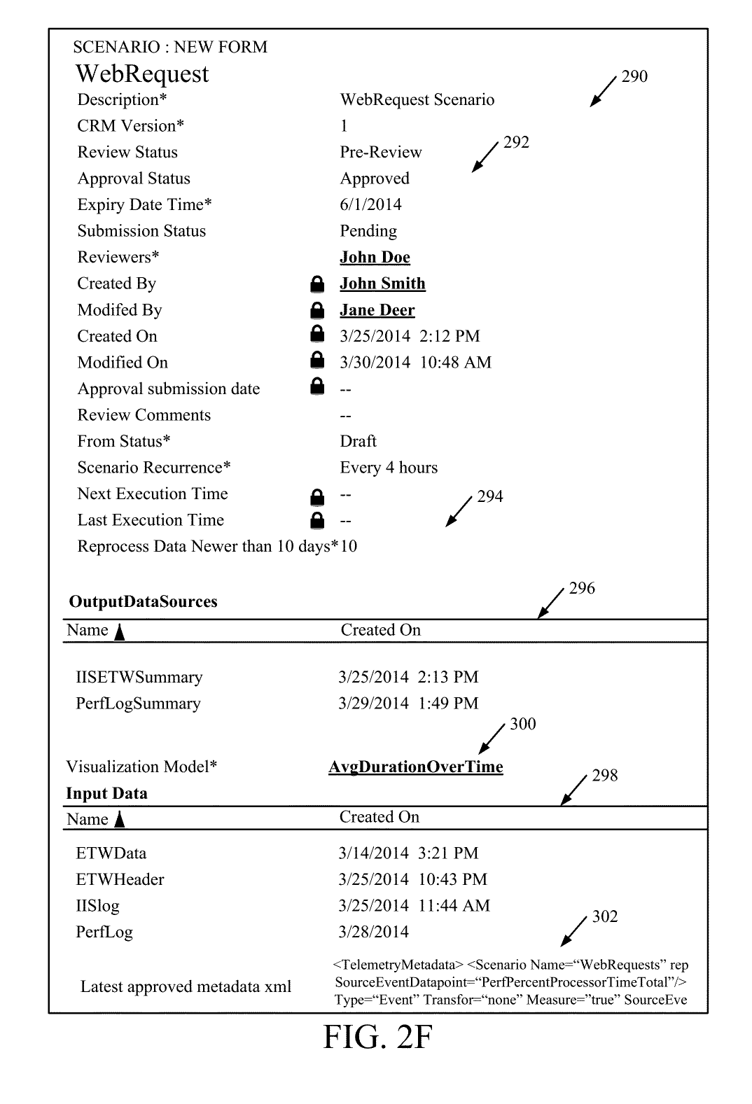

FIGS. 1-1 and 1-2 (collectively FIG. 1) is a block diagram of one illustrative data collection and analysis architecture 100. Architecture 100 shows a business system 102, from which telemetry data collection system 104 collects telemetry data and stores it in telemetry data store 106. Architecture 100 also illustratively includes data analysis and visualization system 108. System 108 obtains data from telemetry data store 106 and generates various visualizations of that data for various scenarios that can be modeled by a user. Before describing the overall operation of architecture 100 in more detail, a number of the items shown in architecture 100 will be described.

Business system 102 is shown for the sake of example only. It could be an engineering system or another computer system for which telemetry data is to be collected and analyzed. Business system 102, for instance, can be a CRM system, an ERP system, an LOB system, or another type of business system.

In the embodiment shown in FIG. 1, business system 102 includes processor 110, data store 112, user interface component 114, applications 116, business processing component 118, and it can include other components 120 as well. Data store 112, itself, illustratively includes entities 122, workflows 124, processes 126 and it can include other business data records or other data 128 as well.

Entities 122 illustratively describe and define entities within business system 102. For instance, a vendor entity describes and defines a vendor. A customer entity describes and defines a customer. A business opportunity entity describes and defines a business opportunity. These are only a small number of the various entities that can be defined within business system 102.

Applications 116 illustratively comprise business applications, such as general ledger applications, other accounting applications, inventory tracking applications, business opportunity tracking applications, etc. Business processing component 118 illustratively accesses workflows 124 and processes 126 to run applications 116 on the various entities 122 in order to perform the business operations for the business that is deploying business system 102. In doing so, user interface component 114 illustratively generates user interface displays 130 that can have user input mechanisms 132 for interaction by user 134. The user illustratively interacts with user input mechanisms 132 in order to interact with, and manipulate, business system 102.

As the user 134 performs his or her tasks or activities in business system 102, a variety of different scenarios can be performed by business system 102. A simplified example of a scenario is to load a given form, such as a customer form. User 134 may routinely need to view various customer forms and enter or review data on those forms. Thus, one common scenario for user 134 may be to load the customer form.

This scenario has a start point, which corresponds to user 134 providing an input on one of user input mechanisms 132 indicating that the user wishes to have the customer form displayed. The scenario also has an end point at which the form is loaded and rendered to the user. In between the start and end points, various other events and activities can be performed by system 102. For instance, system 102 can access data store 112 to obtain the form. It can then access the data store again to load data into the form. Each of these events or activities may, themselves, have a start and end point and a duration. Thus, the “load customer form” scenario may be defined by a plurality of different events, activities (which can be a sequence of events), and they can generate a variety of different types of data, such as the start time, the end time, the duration, the frequency with which the event, activity or scenario was performed, etc.

Telemetry data collection system 104 illustratively includes a collection agent 136 and an uploader component 138. Telemetry agent 136 can be a distributed agent service, or it can be deployed in another way. It illustratively collects telemetry data 140 from business system 102. The telemetry data 140 can be a wide variety of different types of data, such as events and the information that defines the events (such as start time, count, duration, end time, etc.). Uploader component 138 can be embodied as a scalable uploading service, or it can be embodied in other ways. It uploads telemetry data 140 to telemetry data store 106 and stores it, in one embodiment, as event logs 142. It can store it in other ways 144 as well.

In one embodiment, telemetry data collection system 104 also includes scrubber component 146. Scrubber component 146 accesses event logs 142 and scrubs the data (such as by removing noisy data, placing the data in a given, expected format, etc.) and re-stores the data as processed event logs 148.

Data analysis and visualization system 108, in the embodiment shown in FIG. 1, includes scenario modeling system 150, scenario analysis system 152, scenario analysis data store 154, scenario data server 156, visualization system 158, processor 160, and it can include other items 162 as well. Scenario modeling system 150 generates a modeling user interface display 164 with modeling user input mechanisms 166 for interaction by user 168. In one embodiment, user 134 can be the same as user 168, and this is indicated by arrow 170. In another embodiment, however, the two user are different.

In any case, user 168 interacts with scenario modeling system 150 through user input mechanisms 166 in order to define a scenario model 172 for which user 168 wishes data to be collected and analyzed. Scenario modeling is described in greater detail below with respect to FIGS. 2-2F.

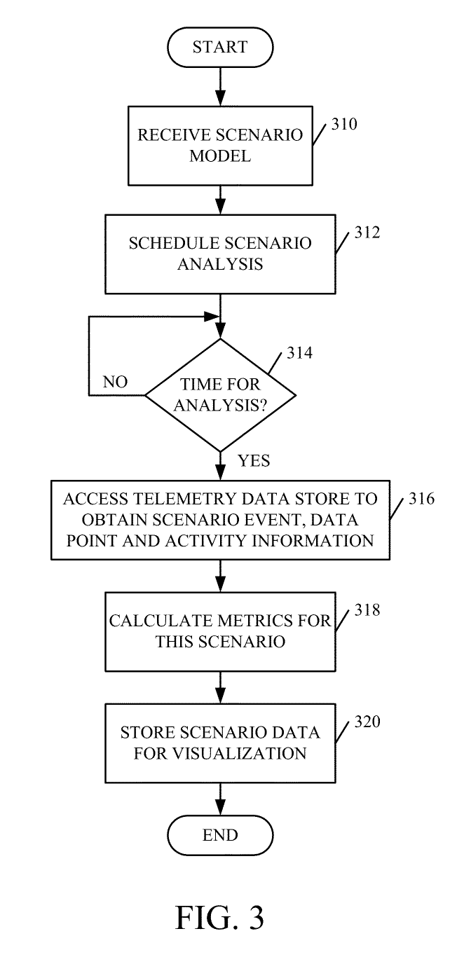

Scenario analysis system 152 illustratively includes scheduler component 174 and analyzer component 176. Scheduler component 174 schedules analysis runs for the various scenarios that are modeled by scenario models 172. Analyzer component 176 obtains data from processed events logs 148 in data store 106 and runs the analysis for the various scenario models 172. In one embodiment, analyzer component 176 generates one or more histograms for each of the key performance indicator metrics corresponding to a given scenario, and the histograms can be used for comparing indicator metrics. This makes the computation map-reducible and reporting additive in nature. The analyzed data, for the various modeled scenarios, is then stored in scenario analysis data store 154 as scenario data 178-180. Performing the analysis to generate scenario data 178-180 is described in greater detail below with respect to FIG. 3.

Scenario data server 156 illustratively serves the various scenario data 178-180 to various different visualization systems 158. Visualization systems 158 can be a wide variety of different types of clients, such as spread sheet clients, business intelligence clients, database management services, etc. In the embodiment shown in FIG. 1, visualization system 158 illustratively includes drill down/roll up component 182, display generator 184 and it can include other components 186 as well.

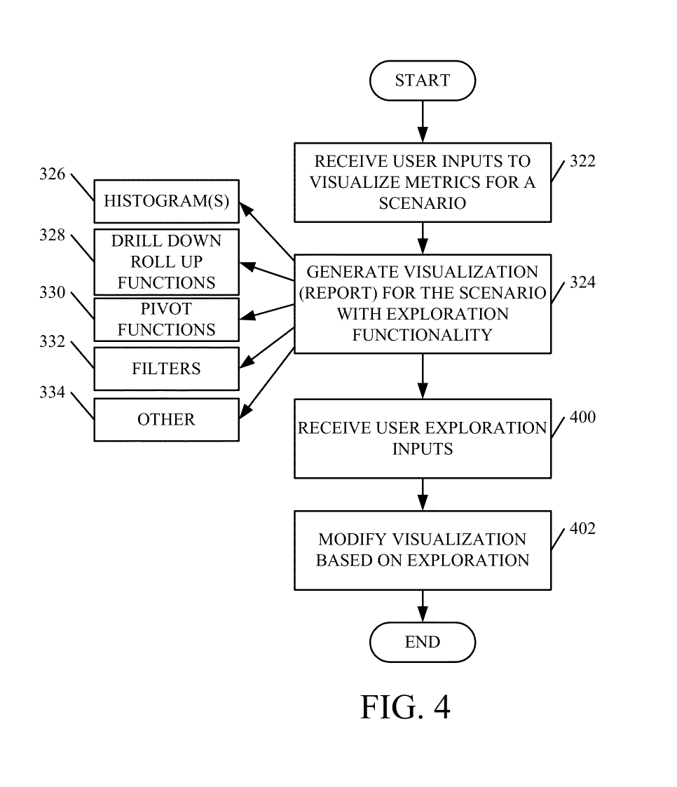

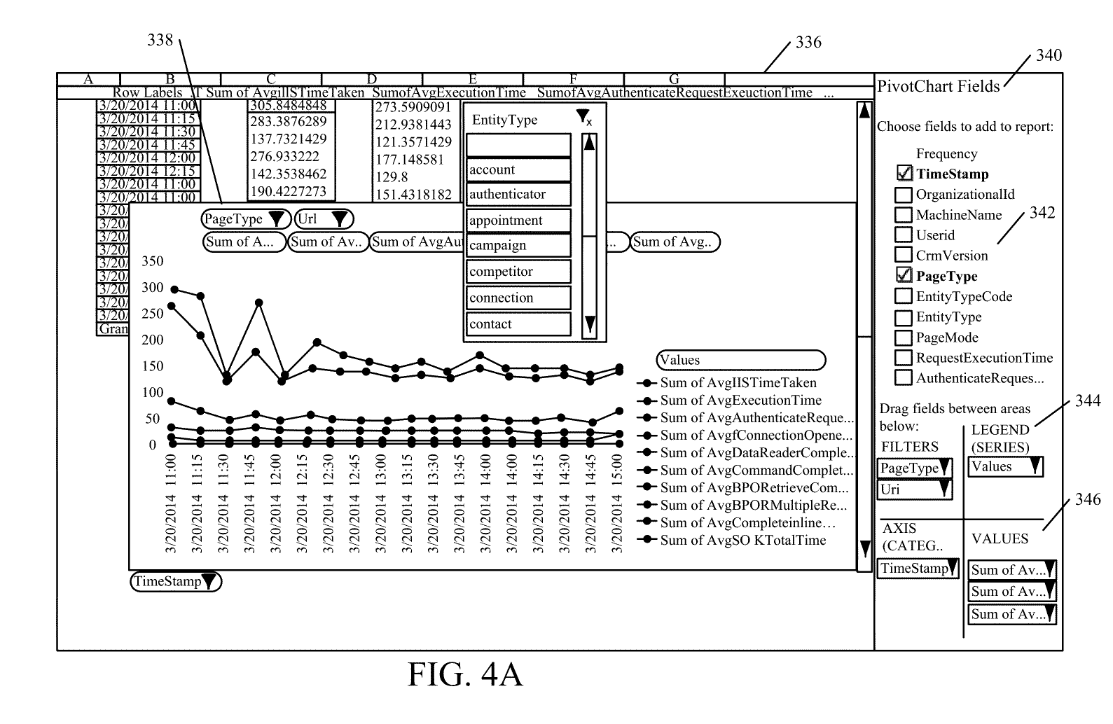

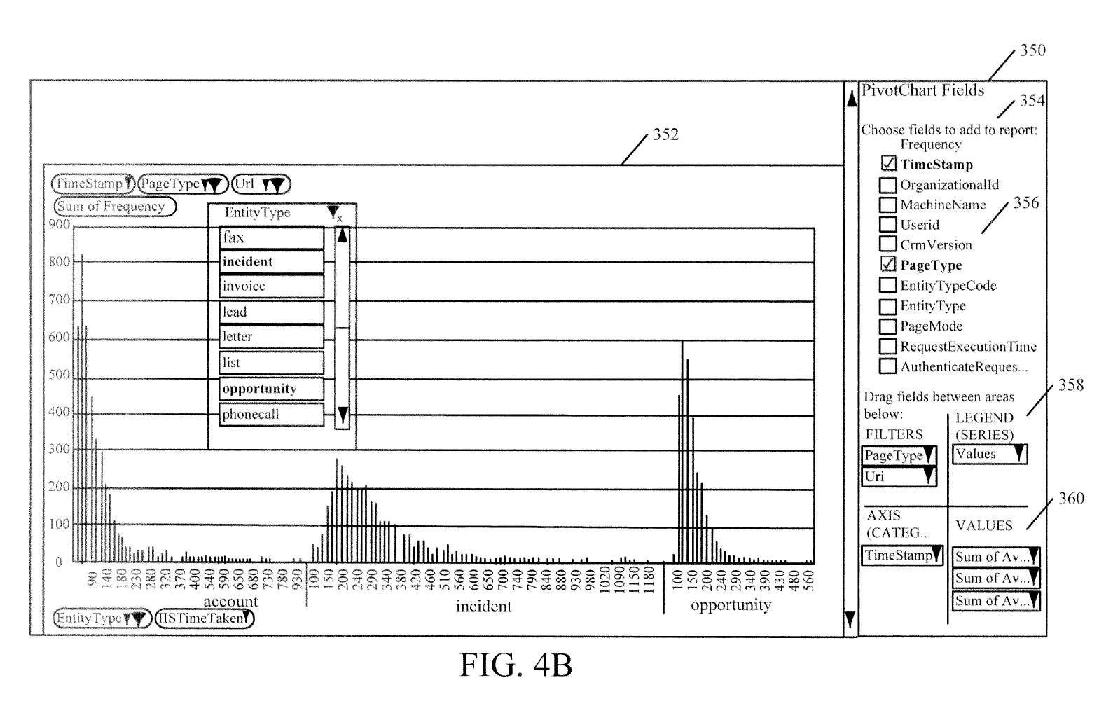

Display generator 184 illustratively generates various scenario visualizations 188 for the various scenarios that are modeled. Scenario visualization 188 illustratively includes data 190 and user input mechanisms 192. A user 194 (which can be the same as, or different from, users 134 and 168) can interact with user input mechanisms 192 to perform explorations on the data presented by scenario visualization 188. In one embodiment, for instance, drill down/roll up component 182 in visualization system 158 generates, as user input mechanisms 192, drill down and roll up mechanisms. The user can actuate these input mechanisms to perform drill down and roll up functionality to see more or less detailed information on the given visualization. In addition, user input mechanisms 192 can be a wide variety of other user input mechanisms as well, such as pivot functions, filters, etc. Generating the visualization is described in greater detail below with respect to FIGS. 4-4B.

FIG. 2 is a flow diagram illustrating one embodiment of the operation of scenario modeling system 150 in allowing user 168 to model scenarios for data collection and analysis. A scenario is a set of events and activities with which make up a logical or business scenario of interest. Events and activity instances for a scenario are tied together by a parent scenario identifier, which can be a correlating identifier, a timestamp, or a machine name, among other things. Each scenario can include temporal activities and sub-activities as well as spatial data which provides contextual details for different instances of a given scenario. Each activity can have a duration metric and other associated metrics, such as counts, types, etc. Activities and spatial data are defined based on events which are raw instrumentation events. The parent scenario identifier is used to tie events belonging to each instance of a given scenario. A child scenario identifier is used to track related and child scenarios that are spawned from a parent scenario.

Scenario modeling system 150 first receives user inputs indicating that user 168 wishes to access modeling system 150. This is indicated by block 200 in FIG. 2. This can take a wide variety of different forms. For instance, the user can provide authentication information (such as a username and password) 202, or it can be done in other ways 204.

Scenario modeling system 150 then receives a set of identified events and data points that can be used to define any scenario within business system 102. Receiving the set of identified events and data points is indicated by block 206 in FIG. 2. The particular events and data points that can be used by scenario modeling system 150 to model a scenario will vary based upon the particular system where the scenarios are being modeled. System 150 can obtain these events and data points in a wide variety of different ways as well. For instance, in one embodiment, scenario modeling system 150 automatically obtains the events and data points from business system 102. This is indicated by block 208. In another embodiment, system 150 can receive user inputs defining the various events and data points, from a user, an administrator, etc. This is indicated by block 210. System 150 can receive the set of events and data points that can be used to model scenarios in other ways as well, and this is indicated by block 212.

Scenario modeling system 150 then generates a display that allows user 168 to select events that can be used to define a given scenario. This is indicated by block 232 in FIG. 2. System 150 then receives user inputs selecting events to define activities within the scenario. This is indicated by block 234. System 150 then receives user inputs selecting fields (e.g., data points), events and activities that are configured to define the scenario. This is indicated by block 236.

By way of example, the user interface displays allow the user to provide inputs to stitch events or other metadata entities together into scenarios. The metadata entities that are defined in order to configure a scenario include events which are raw events from the monitored system (e.g., business system 102). Data points include spatial and temporal metric points in the event. Activities are combinations of one or more events that determine a functional or idle state of the system, a single end event, along with a time indicator that indicates a time in a state, or begin and end events.

System 150 then generates a display for defining metrics to report for the current scenario. This is indicated by block 238 in FIG. 2. Metrics can include key performance indicators (KPIs) 240 that are calculated based on data points or durations. The metrics can also include transformations 242 which can be expressed over data points to aggregate at a per scenario instance granularity, or a different granularity. The metrics can include quantization methods 244 for generating histograms 246 and the metrics can be reported as histogram dimensions with a single frequency count as the measure.

The metrics can be defined in other ways 248 as well.

System 150 then receives metric definition inputs from the user in order to define the metrics that are to be reported for the configured scenario. This is indicated by block 250 in FIG. 2.

System 150 then generates a user interface display that allows user 168 to define the visualization that the user wishes to use in order to visualize the metrics for this scenario. This is indicated by block 252. The user then provides visualization inputs defining the visualization for this scenario, as indicated by block 254. A visualization includes a configuration for exploring and reporting the various metrics that are defined for the scenario.

System 150 then outputs the scenario model 172 (as a set of metadata) that defines the scenario. This is indicated by block 256.

FIGS. 2A-2F show various examples of displays that can be generated to define a scenario model. FIG. 2A shows one example of a user interface display 214 that lists a set of events that can be used to construct a scenario. In the embodiment shown in FIG. 2A, a list of events are provided with an event name in column 216 and a creation date in column 218. The events can be listed in other ways as well. These events can be selected and ordered to model a scenario.

FIG. 2B shows one embodiment of a user interface display 220 that identifies event fields, for an event from the list shown in FIG. 2A, that can be used for constructing a scenario. Display 220 includes an event name for a given event indicated generally by number 222. The event shown in display 220 also includes a plurality of identifying fields 224. The identifying fields include an event name and description, a source version of the system where the event is generated, any conditions for generating the event, and a data source for the event. The event fields also include a data type field, and a set of event data points shown generally at 226. The event data points define the payload that the particular event is carrying. The data points are listed generally at 228. The event shown in FIG. 2B includes a set of related scenario identifying information 230. In the embodiment illustrated, information 230 includes an identifier for a child scenario source, a parent scenario source, and it can include other information as well.

FIG. 2C shows another user interface display 260 that displays a data point definition. Data points are associated with events as shown in FIG. 2B. The particular data point shown in FIG. 2C is the “AsyncJobLoadEventTimeOffset” data point shown at 228 in FIG. 2B. The data point shown in FIG. 2C includes identifying information such as name and description shown generally at 262. It includes an event 264 that identifies the events for which this data point provides data. It includes a data source name 266 that identifies the data source and a data source field ID 268 that identifies the field of the data source from which data is to be extracted for the event identified at 264. It also includes an aggregation type and data type indicated generally at 270 and 272, respectively.

FIG. 2D shows one embodiment of a user interface display 274 that identifies an output data list. The list includes a name and description generally defined at 276, and it also includes a metrics list 278. Metrics list 278 includes a list of metrics that are defined for the given scenario. The metrics 278 are the information that user 168 sees when the user reviews the visualization for the current scenario.

FIG. 2E is another user interface display 280. Display 280 shows a specific metric definition for a metric that can be included in list 278 shown in FIG. 2D. The metric definition includes a name, description, and metric type illustrated generally at 282. It can include an identification of a statistical model, quantization, statistical data type and transform that are used in the metric. This is indicated generally at 284. It can also include a source event data point illustrated generally at 286 and other information (such as a begin event data point, an end event data point, and whether the metric is a measure). This is indicated generally at 288.

FIG. 2F shows one embodiment of a user interface display 290 that shows an entire scenario, that has been completely configured. It includes a variety of information, such as a description, a version number for the business system from which the information was taken, and a variety of other identifying information indicated generally at 292. It can also include a scheduling portion 294 that shows the next and last execution times for the analysis to be performed for this scenario.

Output data sources section 296 identifies the particular output data sources for the scenario, and input data sources section 298 defines the input data that is to be used in analyzing the scenario. Visualization model portion 300 identifies a visualization model which has been selected, or defined by user 168 in order to visualize the metrics calculated for this scenario.

FIG. 2F shows that the scenario also illustratively includes a markup language portion that can be used to generate an analysis job for this scenario. It will be noted that the user interface displays shown in FIGS. 2A-2F are exemplary only. A wide variety of other user interface displays can be used as well.

FIG. 3 is a flow diagram illustrating one embodiment of the operation of scenario analysis system 152 in performing an analysis to generate new or updated metrics for a given scenario. Scenario analysis system 152 first receives the scenario model 172 from scenario modeling system 150. This is indicated by block 310 in FIG. 3.

Scheduler 174 then schedules a scenario analysis job in system 152. This is indicated by block 312.

Analyzer 176 then determines whether it is time to perform analysis for the scenario modeled by scenario model 172. This is indicated by block 314. It can be time to run an analysis for a variety of different reasons. For instance, if new data has been collected from business system 102, that pertains to the present scenario, then analyzer 176 can perform an updated analysis on the data. In addition, when the scenario has just recently been modeled, analyzer 176 may perform an initial analysis. Scheduling can be performed in other ways as well.

In any case, analyzer 176 access the telemetry data store 106 to obtain the scenario event, data point and activity information, from processed event logs 148. This is the information that is needed by analyzer 176 to perform the scenario analysis, and to calculate the various metrics for the given scenario. Accessing telemetry data store 106 is indicated by block 316 in FIG. 3.

Analyzer 176 then calculates the various metrics defined for the present scenario. This is indicated by block 318. In one embodiment, analyzer 176 generates histograms of the various KPIs and sub-KPIs from the event logs. Each KPI can be indicated by a dimension and frequency count. This data enables the user to drill down to any detail, starting from a higher level KPI (such as one calculated using a transformation). Once the metrics are calculated, they are stored in scenario analysis data store 158 as a set of scenario data (e.g., scenario data 178 or 180) for the given scenario. This is indicated by block 320.

FIG. 4 is a flow diagram illustrating one embodiment of the operation of visualization system 158 in generating the specified visualization for the various metrics corresponding to the given scenario. Visualization system 158 first receives user input indicating that the user wishes to visualize the metrics for a specific scenario. This is indicated by block 322. Display generator 184 then generates the visualization (or report) for the identified scenario, with exploration functionality. This is indicated by block 324 in FIG. 4.

In one embodiment, the visualization generates the histograms described above. Drill down/roll up component 182 provides drill down and roll up functionality that enables the user to drill down to any detail, starting from a high level KPI value. The roll up functionality allows the user to aggregate data upward from any detailed drill down. The drill down and roll up values are also illustratively generated as histograms. Thus, the user can easily obtain an idea of the demographics (like clustering of data, long tail data, outliers, etc.) which can be used to interpret the analysis results. Both the KPI calculation, and the reporting as histograms, are additive in nature, and are map-reducible, as opposed to generating descriptive statistics on the data. The histograms can be used for KPI tracking between different time intervals and using other pivot points. A comparison coefficient metric, such as the Kolmogorov-Smimor (K-S) test metric, can be used for comparison of histograms to understand how KPIs have changed and whether the changes indicate any problematic issues. The histogram comparisons are non-parametric and provide more comprehensive results than comparing other descriptive statistical numbers (such as the average, the 95th percentile, the median, etc.). Thus, this comparison reduces any false positive or negative triggers compared to some current systems.

Generating the visualization with histograms is indicated by block 326 in FIG. 4. Enabling drill down and roll up functionality on the visualization is indicated by block 328. The exploration functionality can also include a variety of other pivot functions 330 and filters 332. Of course, the visualization can be provided in other ways as well, and this is indicated by block 334.

FIG. 4A shows one embodiment of a user interface display 336 that indicates a particular visualization for a scenario. Display 336 includes a chart 338 that shows changes in KPI (with the average computed from histograms) over time. It also illustratively includes a pivot chart 340 that allows the user to pivot the data based on various metrics defined in list 342. Further, display 336 includes a set of filter user input mechanisms 344 that allow the user to filter the displayed data based on a variety of predefined filters. Axis definition user input mechanism 346 allows the user to drag various metrics or filter items to the different axes on chart 338 so that they can be displayed as desired by the user.

FIG. 4B shows another embodiment of a user interface display 350. Display 350 is a spreadsheet display that shows a histogram comparison of response time for different entity form load scenarios. The histogram is indicated generally at 352. The histogram comparison provides details on actual response time, different clusters of workloads, long tail characteristics, etc. Pivot chart 354 allows drill down and roll up across dimensions. By selecting the different metrics from list 356, the user can choose which particular metrics to be displayed and, again, they can be filtered using filter input mechanisms 358 and axis definitions 360.

Given the displays shown in FIGS. 4A and 4B, the user can provide various exploration inputs indicating that the user wishes to drill down, roll up, display different metric analyses, change the axes for the histogram charts or other things. Receiving the user exploration inputs is indicated by block 400 in FIG. 4.

In response, visualization system 158 modifies the visualization based on the exploration inputs. This is indicated by block 402.

It can this be seen that scenario modeling system 150 allows user 168 to model scenarios by stitching together events, data points, activities, etc. It also allows the user to define various KPIs, transformations, quantization methods and other items to define the metrics that are to be reported for the scenario. Further, it allows the user to define a visualization that the user wishes to use to visualize the analytics. This can be done after the fact, and the event logs can be mined in order to perform analytics for the defined scenario. Because the analytics are reported as histograms the calculation and presentation processes are additive in nature and allow an effective comparison of histograms to understand how KPIs have changed and whether these changes indicate problems. The comparison reduces false positive and negative indications compared to comparison of conventional telemetry data.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

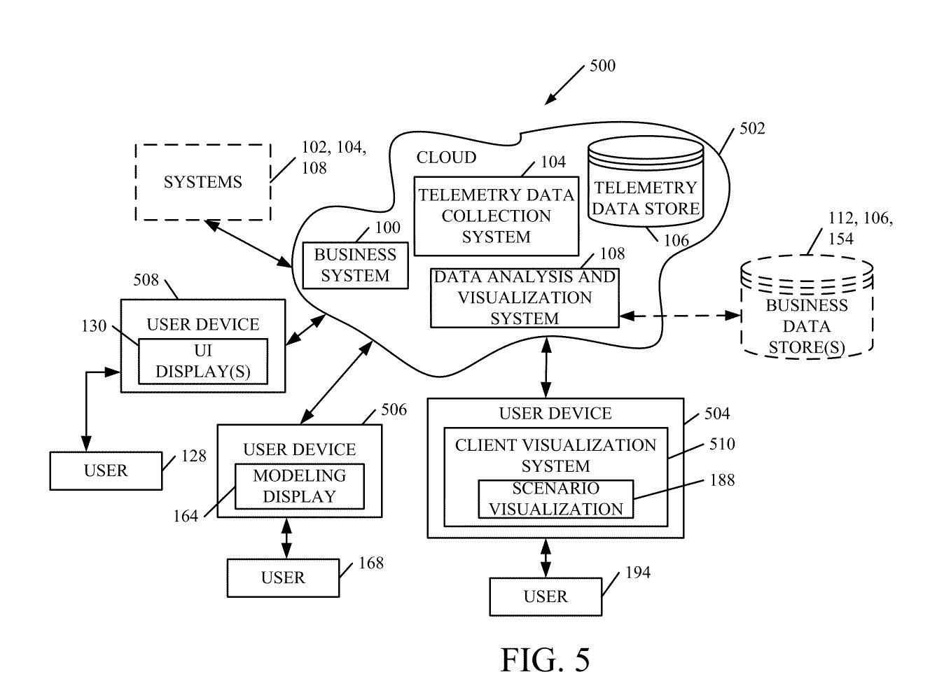

FIG. 5 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 5, some items are similar to those shown in FIG. 1 and they are similarly numbered. FIG. 5 specifically shows that components of architecture 100 can be located in cloud 502 (which can be public, private, or a combination where portions are public while others are private). Therefore, users 128, 168, and 194 use user devices 504, 506 and 508 to access those systems through cloud 502. Each of the user devices can have client-side components for interacting within architecture 100. By way of example, device 504 shows client visualization system 510 that can be used in rendering visualization 188.

FIG. 5 also depicts another embodiment of a cloud architecture. FIG. 5 shows that it is also contemplated that some elements of architecture 100 can be disposed in cloud 502 while others are not. By way of example, data stores 106, 112 and 154 can be disposed outside of cloud 502, and accessed through cloud 502. In another embodiment, any of systems 102, 104 or 108 can also be outside of cloud 502. Regardless of where they are located, they can be accessed directly by devices 504, 506 and 508 through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

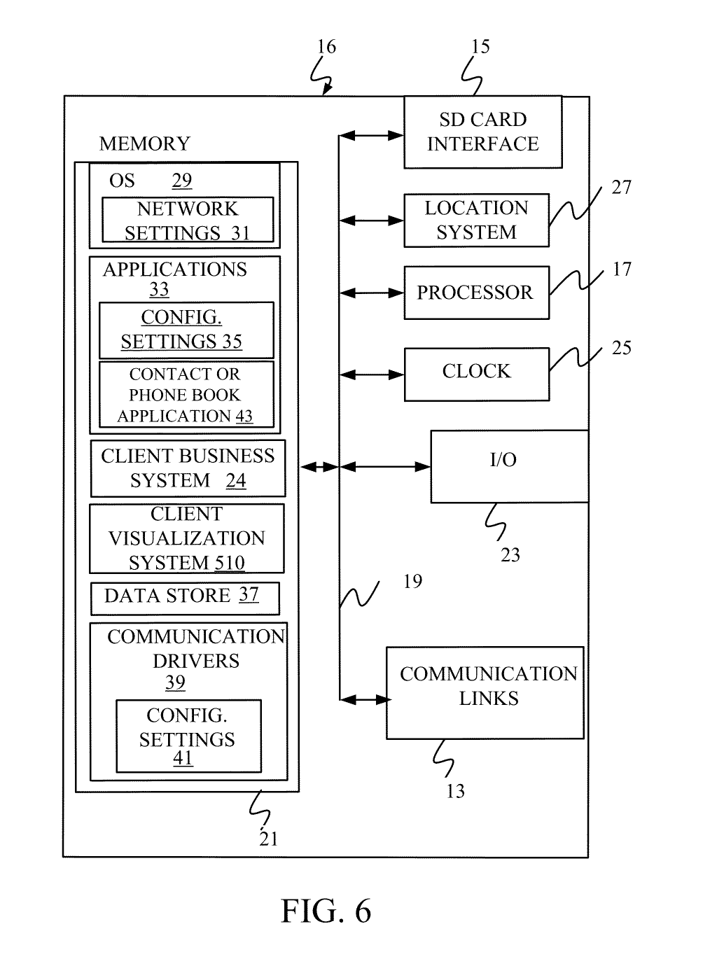

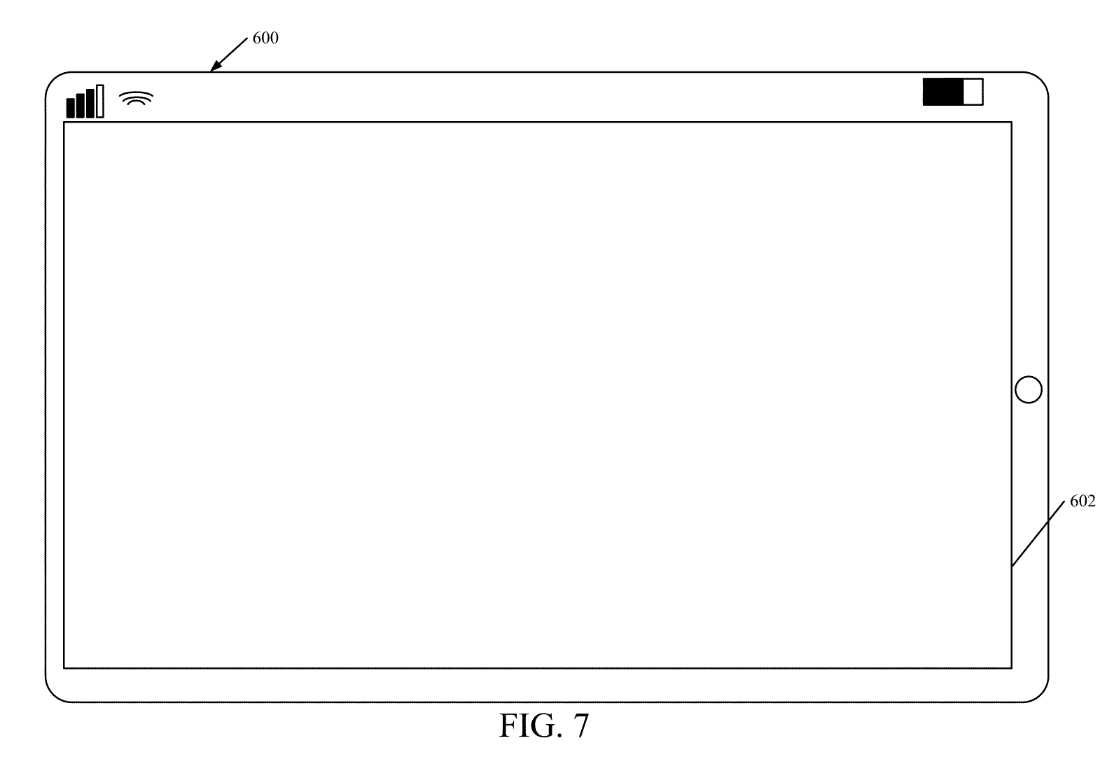

FIG. 6 is a simplified block diagram of one illustrative embodiment of a handheld or mobile computing device that can be used as a user's or client's hand held device 16, in which the present system (or parts of it) can be deployed. FIGS. 7-10 are examples of handheld or mobile devices.

FIG. 6 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like client-side components or others) are received on a removable Secure Digital (SD) card that is connected to a SD card interface 15. SD card interface 15 and communication links 13 communicate with a processor 17 (which can also embody processors 110 or 160 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 or other client-side components (such as system 510) which can run various business applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 7, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

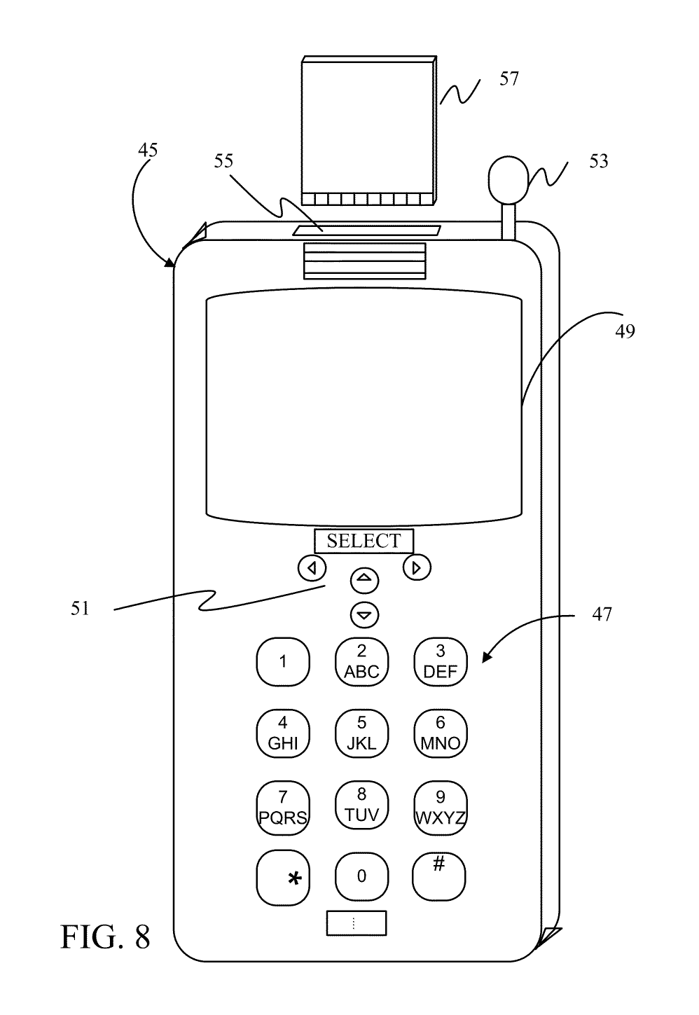

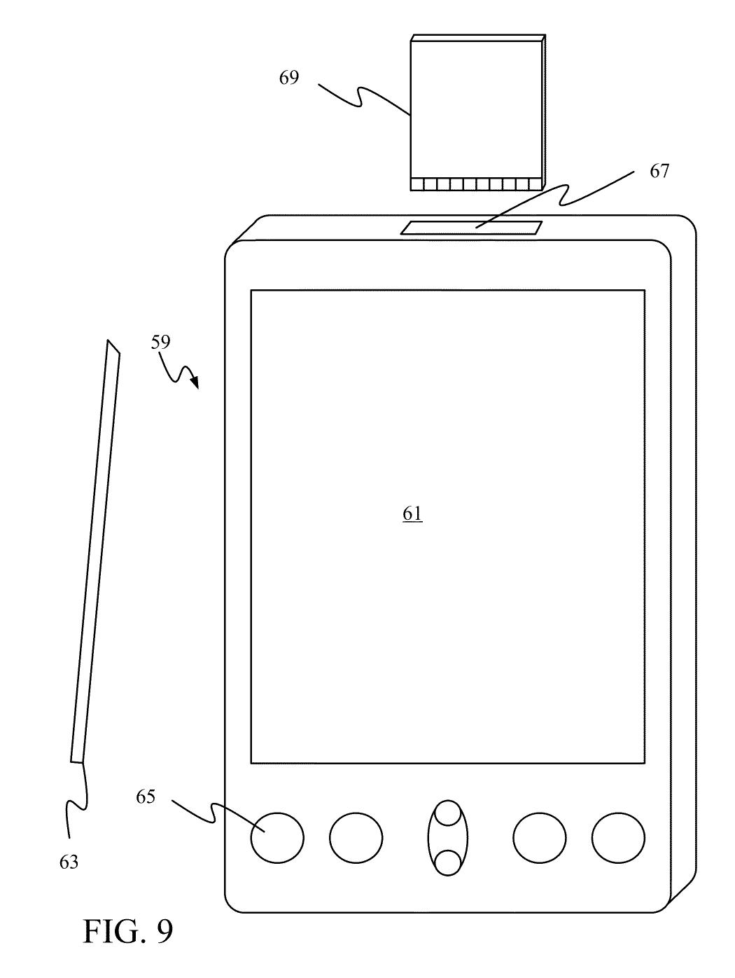

FIGS. 8 and 9 provide additional examples of devices 16 that can be used, although others can be used as well. In FIG. 8, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1×rtt, and Short Message Service (SMS) signals. In some embodiments, phone 45 also includes a Secure Digital (SD) card slot 55 that accepts a SD card 57.

The mobile device of FIG. 9 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

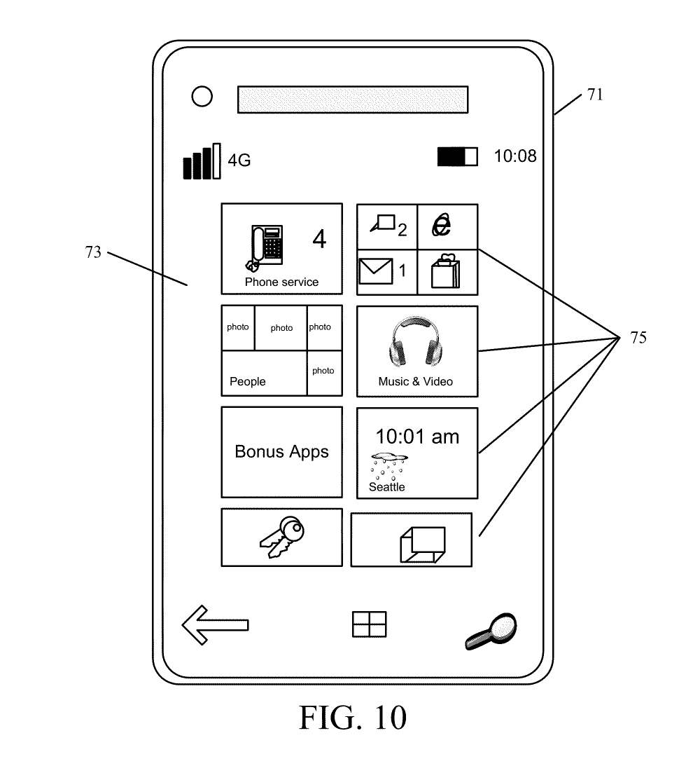

FIG. 10 is similar to FIG. 8 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

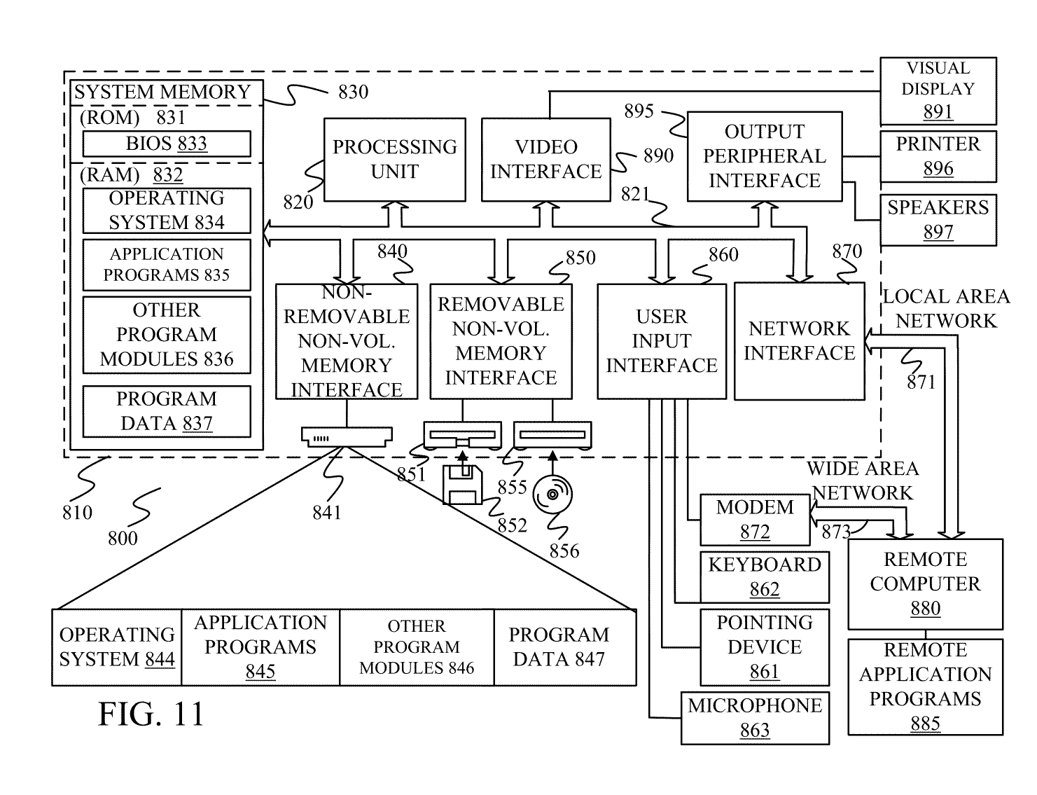

FIG. 11 is one embodiment of a computing environment in which architecture 100, or parts of it, (for example) can be deployed. With reference to FIG. 11, an exemplary system for implementing some embodiments includes a general-purpose computing device in the form of a computer 810. Components of computer 810 may include, but are not limited to, a processing unit 820 (which can comprise processors 110 or 160), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a data analysis system, comprising:

an analyzer component that obtains a scenario model indicative of a scenario

in a computing system and accesses system monitoring logs to obtain system

monitoring data indicative of characteristics of the scenario and calculates metric

values indicated by the scenario model, as additive metric values; and

a visualization system that generates a visualization of the additive metric

values for the scenario.

Example 2 is the data analysis system of any or all previous examples wherein the computing system comprises a business system and wherein the scenario comprises a business scenario in the business system.

Example 3 is the data analysis system of any or all previous examples wherein the visualization system comprises:

a drill component that provides drill user input mechanisms on the visualization that are actuated to provide a more detailed view of the additive metric values or an aggregated view of the additive metric values.

Example 4 is the data analysis system of any or all previous examples wherein the visualization system displays the additive metric values as histogram dimensions.

Example 5 is the data analysis system of any or all previous examples wherein the visualization system displays the histogram dimensions, each having a single frequency count as a corresponding measure.

Example 6 is the data analysis system of any or all previous examples and further comprising:

a scenario modeling system that generates modeling user interface displays with modeling user input mechanisms that are actuated to generate the scenario model.

Example 7 is the data analysis system of any or all previous examples wherein the scenario modeling system generates the modeling user interface display with an event identifier user input mechanism that is actuated to identify an event from the business system that is included in the scenario.

Example 8 is the data analysis system of any or all previous examples wherein the scenario modeling system generates the modeling user interface display with a data point identifier user input mechanism that is actuated to identify a data point for the event.

Example 9 is the data analysis system of any or all previous examples wherein the data point comprises at least one of a temporal data point that indicates a temporal characteristic of the event, and a spatial data point that indicates a context of the event in the business system.

Example 10 is the data analysis system of any or all previous examples wherein the scenario modeling system generates the modeling user interface display with an activity identifier user input mechanism that is actuated to identify a set of events as corresponding to an identified activity from the business system that is included in the scenario.

Example 11 is the data analysis system of any or all previous examples wherein the scenario modeling system generates the modeling user interface display with a scenario identifier user input mechanism that is actuated to identify a set of events and activities from the business system that define the scenario.

Example 12 is the data analysis system of any or all previous examples wherein the scenario modeling system generates the modeling user interface display with a metric identifier user input mechanism that is actuated to identify an event from the metric values in the business system that are included in the scenario.

Example 13 is the data analysis system of any or all previous examples and further comprising:

a data collection system that collects the system monitoring data from one or more runtime instances of the business system; and

a scheduler component that schedules the analyzer component to calculates the metric values for the scenario as the system monitoring data is received from the data collection system.

Example 14 is a method, comprising:

displaying a scenario modeling user interface display with scenario modeling user input mechanisms that are actuated to model a scenario in a computing system, the modeled scenario identifying metrics indicative of characteristics of the modeled scenario, the metrics being histogram dimensions with a corresponding single measure;

accessing a data log of monitor data for the computing system;

calculating the metrics for the modeled scenario based on the monitor data in the data log; and

generating a visualization of the metrics for an instance of the scenario in the computing system.

Example 15 is the method of any or all previous examples and further comprising:

receiving additional monitor data from the computing system; and

updating the metrics using an additive update to the histogram dimensions.

Example 16 is the method of any or all previous examples wherein the computing system comprises a business system, and wherein displaying the scenario modeling user interface display comprises:

displaying event definition user input mechanism actuated to define a set of events in the modeled scenario; and

displaying a data point user input mechanism actuated to define data points for the set of events.

Example 17 is the method of any or all previous examples wherein displaying the scenario modeling user interface display comprises:

displaying an activity user input mechanism actuated to define a set of events that comprise a monitored activity in the modeled scenario.

Example 18 is the method of claim 17 wherein generating the visualization, comprises:

displaying detail user input mechanisms that are actuated to change a level of detail in the visualization of the metrics for the instance of the scenario.

Example 19 is the method of any or all previous examples wherein displaying the detail user input mechanism comprises:

displaying a drill down that is actuated to drill down to a histogram display displaying the histogram dimensions; and

displaying an aggregate display that is actuated to aggregate histogram dimensions to display an aggregated display.

Example 20 is a computer system, comprising:

a scenario modeling system that generates modeling user interface displays with modeling user input mechanisms that are actuated to generate a scenario model that models a scenario executed in a second computing system;

an analyzer component that obtains the scenario model and accesses system monitoring logs to obtain system monitoring data indicative of characteristics of the scenario and calculates metric values indicated by the scenario model, as additive metric values; and

a visualization system that generates a visualization of the additive metric values for the scenario, along with detail mechanisms that are actuated to change a detail level displayed in the visualization.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A data analysis system, comprising:
an analyzer component that obtains a scenario model indicative of a scenario in a computing system and accesses system monitoring logs to obtain system monitoring data indicative of characteristics of the scenario and calculates metric values indicated by the scenario model, as additive metric values; and
a visualization system that generates a visualization of the additive metric values for the scenario.

2. The data analysis system of claim 1 wherein the computing system comprises a business system and wherein the scenario comprises a business scenario in the business system.

3. The data analysis system of claim 2 wherein the visualization system comprises:
a drill component that provides drill user input mechanisms on the visualization that are actuated to provide a more detailed view of the additive metric values or an aggregated view of the additive metric values.

4. The data analysis system of claim 3 wherein the visualization system displays the additive metric values as histogram dimensions.

5. The data analysis system of claim 4 wherein the visualization system displays the histogram dimensions, each having a single frequency count as a corresponding measure.

6. The data analysis system of claim 3 and further comprising:
a scenario modeling system that generates modeling user interface displays with modeling user input mechanisms that are actuated to generate the scenario model.

7. The data analysis system of claim 6 wherein the scenario modeling system generates the modeling user interface display with an event identifier user input mechanism that is actuated to identify an event from the business system that is included in the scenario.

8. The data analysis system of claim 7 wherein the scenario modeling system generates the modeling user interface display with a data point identifier user input mechanism that is actuated to identify a data point for the event.

9. The data analysis system of claim 8 wherein the data point comprises at least one of a temporal data point that indicates a temporal characteristic of the event, and a spatial data point that indicates a context of the event in the business system.

10. The data analysis system of claim 8 wherein the scenario modeling system generates the modeling user interface display with an activity identifier user input mechanism that is actuated to identify a set of events as corresponding to an identified activity from the business system that is included in the scenario.

11. The data analysis system of claim 10 wherein the scenario modeling system generates the modeling user interface display with a scenario identifier user input mechanism that is actuated to identify a set of events and activities from the business system that define the scenario.

12. The data analysis system of claim 11 wherein the scenario modeling system generates the modeling user interface display with a metric identifier user input mechanism that is actuated to identify an event from the metric values in the business system that are included in the scenario.

13. The data analysis system of claim 12 and further comprising:
a data collection system that collects the system monitoring data from one or more runtime instances of the business system; and
a scheduler component that schedules the analyzer component to calculates the metric values for the scenario as the system monitoring data is received from the data collection system.

14. A method, comprising:
displaying a scenario modeling user interface display with scenario modeling user input mechanisms that are actuated to model a scenario in a computing system, the modeled scenario identifying metrics indicative of characteristics of the modeled scenario, the metrics being histogram dimensions with a corresponding single measure;
accessing a data log of monitor data for the computing system;
calculating the metrics for the modeled scenario based on the monitor data in the data log; and
generating a visualization of the metrics for an instance of the scenario in the computing system.

15. The method of claim 14 and further comprising:
receiving additional monitor data from the computing system; and
updating the metrics using an additive update to the histogram dimensions.

16. The method of claim 15 wherein the computing system comprises a business system, and wherein displaying the scenario modeling user interface display comprises:
displaying event definition user input mechanism actuated to define a set of events in the modeled scenario; and
displaying a data point user input mechanism actuated to define data points for the set of events.

17. The method of claim 16 wherein displaying the scenario modeling user interface display comprises:
displaying an activity user input mechanism actuated to define a set of events that comprise a monitored activity in the modeled scenario.

18. The method of claim 17 wherein generating the visualization, comprises:
displaying detail user input mechanisms that are actuated to change a level of detail in the visualization of the metrics for the instance of the scenario.

19. The method of claim 18 wherein displaying the detail user input mechanism comprises:
displaying a drill down that is actuated to drill down to a histogram display displaying the histogram dimensions; and
displaying an aggregate display that is actuated to aggregate histogram dimensions to display an aggregated display.

20. A computer system, comprising:
a scenario modeling system that generates modeling user interface displays with modeling user input mechanisms that are actuated to generate a scenario model that models a scenario executed in a second computing system;
an analyzer component that obtains the scenario model and accesses system monitoring logs to obtain system monitoring data indicative of characteristics of the scenario and calculates metric values indicated by the scenario model, as additive metric values; and
a visualization system that generates a visualization of the additive metric values for the scenario, along with detail mechanisms that are actuated to change a detail level displayed in the visualization.
